(19) United States
(12) Patent Application Publication
(10) Pub. No.: US 2020/0250220 A1
(43) Pub. Date: Aug. 6, 2020

(54) Methods and Apparatuses for Enhancing User Interaction with Audio and Visual Data Using Emotional and Conceptual Content

(71) Applicant: Be Forever Me, LLC, Galisteo, NM (US)

(72) Inventors: Jason Merkoski, Galisteo, NM (US); Lee Caperton, Albuquerque, NM (US)

(21) Appl. No.: 15/780,790

(22) PCT Filed: Dec. 1, 2016
(86) PCT No.: PCT/US16/64387

§ 371 Date: Jun. 1, 2018

Related U.S. Application Data
(60) Provisional application No. 62/262,268, filed on Dec. 2, 2015.

(51) Int. Cl. G06F 16/435; G10L 15/26; G10L 15/197; G10L 25/63; G06F 16/41; G10L 25/54

(52) U.S. Cl. CPC G06F 16/435; G10L 15/26; G10L 25/54; G10L 25/63; G06F 16/41; G10L 15/197

(57) ABSTRACT

A system for digitally archiving, indexing, and retrieving a person's experiences and memories, using both common metadata from digital files and algorithmically-generated attributes from the underlying digital files, to enable a conversational mode of querying data related to a person's life experiences, rather than a specialized technical, and abstract method of querying data.

### TECHNICAL FIELD

This invention relates to the field of digitally archiving, indexing, and retrieving a person's experiences and memories, and to the field of processing audio and video media to facilitate extracting, indexing, searching, or combinations thereof, based on emotional and conversational characteristics in such media.

### BACKGROUND ART

People generate a tremendous amount of content in the course of their lives, although much of this content is never stored. Examples include conversations, personal interactions, and observations a person might make verbally or subvocally. Sometimes this content is explicitly recorded, such as when a person records a conversation, or creates a video of an event.

Current approaches for archiving experiences and memories of a person require manually-intensive curation, such as through creating a photo album, or a scrapbook, or a written biography or video documentary. Digital indexing and searching technology can aid this manual curation process. However, digital indexing typically relies on metadata, which is already digital, and files are rarely tagged explicitly with data on the user's emotional state. Likewise, digital search is usually limited to keyword-based searches, whereas people are more used to a conversational mode of inquiry.

### DESCRIPTION OF INVENTION

This application is related to U.S. provisional application 62/262,268, filed Ser. No. 12/02/2015, which is incorporated herein by reference.

Embodiments of the present invention provide people with a means of effortlessly recording conversations and events (in audio or video form) that they might never have previously archived. This system allows for this digital content to be indexed in the cloud, and searched/retrieved by either the original creator of this content, or others who have access to this content. This can be useful, for example, in cases where a family member is no longer alive, but people wish to ask that family member questions, and hear (in the family member's own words) how they would have responded. This system is also useful for persons who wish to be able to get to know someone else conversationally—such as perhaps an actor, or a movie star, or a scientist—using the digitally archived, indexed, and searchable content as a repository. Unlike previous approaches, the present invention comprises an artificial-intelligence basis, which allows for ad-hoc questioning of a person whose memories and experiences have been digitized. Unlike books or documentaries, which are scripted, the present invention enables an ad-hoc style of question-and-answer engagement.

Embodiments of the present invention provide a system that allows users to provide digital content as input. The content can be audio or video in nature. The content can be archival in nature, such as old 8 mm tapes that have been transferred to digital files, or audio recordings that have been transcoded into MP3 or M4A or any other digital audio file. The content can additionally be created within the system, such as through an app that allows a user to record his/her voice as an audio file, or his/her experience as a video file. These digital inputs are then uploaded either individually or in batch to the cloud for processing. The processing component extracts metadata, and meaning, from the inputs. Examples of metadata include audio timestamps, or geotag locations embedded in the digital files. Examples of meaning include topics being discussed in the audio portion(s) of the digital files, or sentiment(s) inferred from the audio streams, or details of the people in frames of video as recognized through techniques such as pattern-matching and facial recognition. This meaning and metadata can then be indexed, with a novel natural language processing and artificial intelligence system, such that the content of any media file is associated with the metadata and meaning inherent in the media file. This allows the content to be searched or browsed by either the original individual, or by other individuals who have appropriate access (such as family members).

Embodiments of the present invention provide for a search solution that doesn't rely on keyword based searches, which are artificial and not how humans are accustomed to speak. Instead, embodiments of the present invention provide for searching and accessing content based on a conversational interaction mode. Instead of putting keywords in a search box, embodiments of the present invention allow users to use complete or partial sentences to start a search. A determination of what is important when doing the search can be performed by interpreting the conversational language, and extracting the relevant search terms and filters. Examples of such conversational searches include sentences such as “When was I in Los Angeles last year?” and “What does my mother think about apple pie?” Embodiments of the present invention provide capabilities to interpret each sentence, extract the right meaning, and apply the appropriate filters for subject matter, time, location, and who is speaking.

### EXAMPLE USE CASES

Example U1a. In a social network context, such as a social network targeted for members of an extended family, users can upload video and/or audio files of relatives they know. The media files can come from family reunions, family videos, or archival material that was digitized. The uploaded media files can be tagged either explicitly to a given family member, or automatically tagged behind the scenes to an existing family member, based on prior voice prints. The archive of files thus generated by an extended family can be used in this family social network context to create an indexed, searchable repository of media for each family member. Members of the family can subsequently search with and interact with a given family member, by asking natural language questions of a given family member's media archive, and one or more contextually appropriate media files can be played back. This encourages a natural dialog, rather than a “browse-based” or “metadata-based” method of retrieving information. This can be beneficial in a family social network or genealogical situation. Users can interact with these collections of media files through an app or web based method, using keyboard entry of text to ask natural language questions, or using their voice, which can be automatically transcribed on their behalf to then determine the natural language search text.

Example U1b. The same application logic from example U1a can function for a professional social network, where people use audio and video to talk about their skills, accomplishments, jobs, career goals, and the system can use the methods outlined in this document to connect similar people together within the social network.

Example U1c. The same application logic from example U1a can function for an open-ended social network, where an individual can upload audio/video media files outside of a professional or familial context. Using the AI and natural language processing elements outlined in this document, users can search this social network for content, and relevant audio/video media posts will be returned. This is in distinction from current social networking sites, where the content within audio/video posts is not searchable, and only the metadata about those posts is searchable.

Example U2. In an online dating sense, users can upload video and/or audio files of themselves, and the system uses the methods as in the present invention to extract meaning and metadata. The system-generated data can then be used as the basis for matching two individuals together, in a dating context. Based on the number of parameters, such as those related to topics discussed in the media files, word frequency counts, emotional states, and other meaningful data inferred algorithmically from the media files, search engine techniques can be used to provide matches for users. Each user's media file is treated as a document. By iterating through a user's media files and finding documents from other users most-similar to the current document, and then aggregating the results, it is possible to provide a similarity score between users to enable match-making through an online dating site.

Example U3: In a training application, data from a professional practice (in the form of audio and/or video media) can be ingested by the methods described herein, and used to provide expert guidance to end-users. Specifically, in a doctor's office, the doctors and nurses could record videos of their advice on topics of interest to patients, and the entire archive can be made searchable through AI and natural language processing means so that end-users can simply ask questions like “If I have a fever, what should I do?” or “How many days should I have to take Lupron injections for my condition?”

Example U4: In an online job application, users can submit videos of themselves, either as videos which describe their skills and talents, and/or videos which pertain to training they've given, lectures they've given, or presentations they've made. The meaning and data inherent in these videos can be extracted by the methods described herein, and provided to head-hunters or professional recruiters looking for talent. In effect, this is an application which is a search engine for job candidates, but based from video testimonials, not metadata, which is traditionally used on job hunting sites. (Examples of metadata include a list of jobs, years of experience, name of university and date of graduation.)

Example U5. Taken collectively, the content uploaded in any examples from U1 through U4 can provide, over time, a large knowledge base. Whether this knowledge base comes from person-to-person conversations, or academic lectures, or professional presentations, there is a large number of factual data available to be mined. In this example embodiment, the present invention provides a system for “digital immortality” whereby all the facts from one person's life, as mined from the audio/video files previously uploaded, serve to allow the person to continue to have conversations with users over the internet, using the data from the audio/video files. If questions are asked of this person which the person has never answered, the collective aggregated knowledge base across all users can be tapped, to find an answer, and the answer can be spoken back either through synthesized text to speech, or by finding the most relevant audio/video file the original speaker used and presenting that back. This “digital immortality” application uses the collective intelligence of the whole to provide increasingly specific and accurate answers to questions that had not been asked before.

Example U6: a user wishes to query a large amount of content. Rather than searching for specific keywords, the user types questions or statements, which are then uses as inputs (appropriately transformed) into the underlying search engine.

Example U7: as a variation of U6, a user may choose to speak aloud, rather than typing, their search. In this case, appropriate speech-to-text software or services are used on the user's voice to transform it into a textual phrase or question, which is then used as the basis for search.

FIG. 1 is a schematic illustration of an example embodiment of the present invention.

Variation 1. Depending on the digital content provided as input, a given content item to be indexed can either be a video or audio digital file. If it is a video file, the content will be processed through blocks PV1 and PV2, and then the audio stream will be extracted, and then processed through blocks PA1, PA2, PA3, PA4, PA5, and PA6. If the original content item was an audio file, steps PV1 and PV2 will be not be necessary.

Variation 2. Depending on the source of the original content, a given content item will either come from block A1, A2, or A3.

Block A1: the system allows for users of an app to create an audio or video recording within the app. The audio can be saved as an industry-standard M4A, or the video can be saved as an industry-standard MP4. Metadata in either case can be set with parameters that the system can use to identify the source of the content as the app, so that if the same file(s) are later uploaded in steps A2 or A3, the file(s) will be ignored by the system and not reprocessed, since they will already have been processed as part of step A1. Metadata can also be set by the user to identify who is represented inside the media file, e.g., a unique identifier that says that the user's mother and father are speaking in the file. This metadata is optional but can be used by later blocks. Additional user-provided metadata can be present, such as hashtags describing the file, and such as references to comments or questions other users have made about this particular recording. Files selected through A1 can be processed through a downsampling routine to compress the content for upload, and optionally split into smaller pieces (if necessary) to prevent large files from failing to get uploaded if upload timeouts are experiences in step R1. Files can then be saved to the user's device within the app and submitted to step R1 for upload.

Block A2: Through the app, a user can select pre-existing audio or video files that have been taken with other apps on the same device. A similar downsampling and optional splitting process as in block A1 can be applied. Files with metadata set from block A1 are ignored, as they have already been processed.

Block A3: Through the user's PC, a user can select pre-existing personal audio or video files that have been taken in the past. These files can for example have been stored on the user's hard drive. Media files with metadata indicating that the media are commercial music or video files can be skipped from upload. A similar downsampling and optional splitting process as in block A1 can be applied. Files with metadata set from block A1 are ignored, as they have already been processed.

Block R1: The system uploads the digital files from steps A1, A2, or A3 to a secure location in the cloud. A metadata file is also uploaded. The metadata file signals the system to process the digital file through the “P” blocks as needed, and serves to announce that the file upload has been complete. The metadata file also includes basic identifiers, such as for example a secure user token, which identifies the user to the system, the date the upload was initiated, and other basic information related to the processing stages. This can be accomplished with standard protocols such as FTP, SCP, or proprietary networking APIs related to cloud service providers.

Block P1: upon receipt of the digital file, its metadata is scanned. Metadata includes but is not limited to the timestamp of the file, the device type and manufacturer used to record the media, the duration of the media, geotags embedded in the media, the file format of the media, and any proprietary metadata set in steps A1, A2, or A3. The metadata received in step P1 is used to determine whether the file is a video or audio media file, and which step of the process to initiate next. The metadata is also provided to the indexer in step I1 for initial indexing. Some of this can be accomplished through reading EXIF file information from video data, using open source EXIF interpreters, or open source tools like “mediainfo” to extract metadata from files.

Block P2. If the file is a video, steps PV1 and PV2 are taken. Otherwise, step PA1 is taken.

Block PA1. The audio file is downsampled and the number of audio channels can be reduced to one single channel using an open source application such as “avconvert”or “ffmpeg”. A “voice activity detector” algorithm written with proprietary code on an open source platform such as Octave can be run on the file to determine if there is a human speech signal present; if so, blocks PA2 through PA7 are run. Otherwise, the system detects that nobody is speaking, and only metadata about the file is indexed.

Block PA2: Segmentation analysis is applied to the audio signal from the previous block, using a tool such as the open source application “sox” to identify sections with non-trivial amounts of silence, and to use these as break-points in segmenting the file. An example preferred segment size is 20 seconds. So for example, if a user is talking continually for 3 minutes, the system can segment the file into 9 pieces, of 20 seconds each.

Block PA3: The file can be analyzed to find peak noise levels, and the overall file can be adjusted to those noise levels to ensure that on average, this audio file can be played back at the same volume as any other average audio file submitted by this user. A unique fingerprint for the audio file is generated, such as through a tool like the open source “fpcalc” so that if the file is submitted multiple times, only one instance of the file will be indexed and stored.

Block PA4: Mathematical signal processing routines can be applied to the audio data to determine the “sentiment” of the audio file, for example in an open source interpreter such as Octave or a proprietary interpreter such as Matlab, or compiled into runtime code for speed and performance advantages. In example embodiments of the invention, sentiment can be determined through a combination of two measures: activity and valence.

Activity is a representation of the amount of acoustical energy present in a band of the voice utterance being spoken, such as from 0 hertz to 500 hertz. The amount of acoustical energy in a range of frequencies corresponding to the speaker's voice can be normalized relative to the total amount of acoustical energy over all parts of the frequency spectrum in the media file, and represented as a percentage. The amount of acoustical energy can be determined and represented in other manners. As an example, segments of the media having different levels of background sound can be determined or estimated, and normalization performed for each segment. As another example, segments of the media having different valence (described below) can be determined, and the acoustical energy in each segment determined separately (e.g., if a speaker puts much energy into a negative valance phrase and lower energy into a higher valence phrase). Acoustic energy can also be determined separately for each speaker, if the media contains words spoken by multiple speakers. The speaker's usual acoustical energy patterns can also be considered, for example by considering a medium energy statement from a speaker who is typically low energy differently from a medium energy statement from a speaker who is typically high energy. The speaker's energy trends can also be combined with valence and meaning determinations, for example to detect when a speaker spoke with high energy and a negative valence about a topic previously, but currently is speaking with low energy and positive valence about the same topic. Other combinations of acoustical energy determinations with valence, content, and speaker characteristics will be appreciated by those skilled in the art from the descriptions herein.

Valence is a representation of how positive or negative the utterance is. Embodiments of the invention can use the speech-to-text data described previously. The words in the utterance can be compared against a database of valence values. The valence values can correspond to any of various scales. As examples, words like “good” or “bright” might have a score of +1, more intense worlds like “awesome” or “excellent” might have a higher score of +2. Likewise, negative words like “sad” or “awful” have negative values. The average valence for an utterance can be determined. The average activation and average valence can be combined, for example by normalizing across everything the user has spoken thus far, or everything a user has spoken in various subsets such as times of year, or utterances about specific topics, or utterances in certain places (e.g., public versus private spaces), or utterances in the presence of certain other people (e.g., in the presence of family versus at work). Some users speak in a more excitable manner than others, and will show a higher or lower average activation. Some users are also more affected by the setting of their speech, and will show higher or lower average activation based on content or setting. Some users may generally choose to speak more or less negatively or positively, and may speak more or less negatively or positively based on content or setting. By normalizing these scores to the total corpus of content for a given user, we can determine how the current activation and valence compare to normal values for the same user. A representative “sentiment” (or emotion) can be determined, as an example, by plotting these values on an “Activation-Valence” curve, such as the one in FIG. 3. The appropriate “sentiment” state can be determined by the position of the activation and valence values with comparison to a standard reference graph. As an example, the invention can use a graph of at least 13 states, with neutral emotion (zero values) being an acceptable state as well, as shown in the figure. Because this sentiment data is determined in part by valences from spoken words, which is dependent on speech-to-text data, the system lags real-time processing. The “sentiment” can be considered for later searching, e.g., as corresponding to the mood of the speaker at the time of the utterance.

Block PA5: Signal processing routines can be applied to the data to identify the number of speakers in each segment, such as using open source tools like “LIUM” from the University of Maine. Discrete speaker identifiers are assigned. For example, segment 1 of an audio file might contain three speakers, which the system can identify as speaker number S01, S02, and S03.

Block PA6: Speaker identifiers from the previous block can be used, along with user-provided metadata, to identify the names of the speakers in the audio file. In block A1, users can optionally tag metadata for who is in a given media file. If this data is set enough times (as an example, at least 20 times can be suitable in some settings), this can be used as training data. Classifier algorithms running an algorithm such as K-Nearest Neighbors or Naïve Bayes in a classifier framework such as the python scikit environment or the Java-based weka environment can then be applied to the new data in PA6 along with previous training data, to identify the name of who is speaking, along with a probability of accuracy. If the probability is high, the name of the speaker can automatically be tagged as part of the overall P2 meaning processing workflow.

Block PA7: the audio file can be submitted to a commercial speech to text provider, such as AT&T or Nuance. The UTF-8 text is provided as a result, along with an identifier indicating the language originally spoken (such as US English). Based on the text of the audio file, thumbnails can be generated using commercial APIs such as Flickr, which allow users to search for images corresponding to a given piece of text. The image returned from such a search becomes a thumbnail image which can be used to visually identify the media file to the user later, if and when the user browses through the media files.

Block PV1: If the media file is a video, thumbnails are generated from the frame of the video through an open source tool such as a combination of “avconv” or “ffmpeg” to extract images, and an image processing toolchain such as the open source “Image Magick”, which shows the sharpest contrast and the least blur. The video is rotated and cropped if needed through a tool like “ffmpeg” to support a consistent orientation on common playback devices such as smartphones, which typically have video playback in landscape mode, with a 16:9 aspect ratio.

Block PV2: Using a combination of commercial service providers and open source software, such as OpenCV, each frame of the video (at 1 second increments) can be analyzed for the presence of human face(s). If a face is detected, algorithms can be run to determine whether the face(s) is(are) smiling, and how many people are in the frame.

Block I1: Data from metadata block P1, and workflow block P2, can be saved to an index in a database such as SQLLite or Mysql, and a search engine, such as the open source Solr search engine made available by the Apache foundation, in such a way that multi-faceted searches can be run on key metadata and meaning attributes. As an example, approximately 100 attributes can be stored.

Block I2: In the case of textual data being indexed, further steps can be taken to extract meaning. Named entity algorithms using such tools as the Stanford open source named entity parser can be run to detect named entities (such as persons, places, and organizations). The text is analyzed for other high-level abstractions, such as the presence of money, times, and dates. If the media file is part of a larger conversation, the cumulative spoken text can also be stored for ease in indexing. The text can be analyzed in terms of a grammar-tree, using a tool such as the open source NLTK on the python environment, which identifies subjects, objects, and verbs. Key topics and key phrases can be identified. All this data can then be indexed. Likewise, the grammar tree itself is indexed, along with content inside the grammar tree, which includes things like noun phrases (“The shark”), verb phrases (“quickly ate”), and other qualifiers like determinants (“The”) and question words (“What”). The invention also indexes POS (part of speech) tags, so that content where “Lisa” is the subject can be indexed in a way differently from the way where content where “Lisa” is the object of a sentence. This allows the indexing system to differentiate between content for example related to “Lisa quickly ate the shark” from semantically different content like “The shark quickly ate Lisa” which have the same words, but entirely different meanings—this is something which current indexing technology ignores, since typical indexing technology is only focused on the words themselves in content, and not typically their semantic meaning in a sentence.

Block I3: Further refinement of topics, named entities, and common nouns and key phrases can be done using a concept-bank to identify key concepts, such as for example the MIT open source “ConceptNet” system, which can be stored locally to improve performance. For example, if the text includes a phrase such as “World's Series” then terms such as “baseball” and “baseball game” would be added to the index.

In the case where the original media was video, we can also extract objects from the frames of the video using internal or commercial software devoted to object recognition. As examples of objects, consider “sunset”, “plaid shirt”, or “fog”. Any objects visually detected in this manner can also be indexed.

Block S1: Users have the ability to textually search content. The search can take the form of natural language questions, such as “What is your favorite color?” which are entered into a field on an app and submitted for processing, e.g. via HTTP, to a load balancer that intercepts the query, and distributes to custom code which determines the next available host to process the query.

Block S2: When received by the server, the search input is submitted to similar algorithms as in I2. This yields synonyms, variants, and metadata about the search, which can be used in retrieving the proper answer.

Block S3: When received by the server, the search input is submitted to similar algorithms as in I3 to yield additional refinements to the search input.

Block S4: Blocks S2 and S3 expand the search input into a set of discrete tokens which can be matched against fields in the index. A search for “What is your favorite color when you were a child?” can be expanded into a search for a results in which only 1 user is speaking, a result in which the user is providing a declarative answer (and not another question in turn), a result in which the user's sentiment is positive, a result in which terms including ‘favorite, best, number one, ideal, favorite” are expansions upon “favorite”, and “hue, mood, color” are expansions of color. Date extraction indicates a time period in the past, so results are further refined by date to score older results with a higher score. The aggregate of results can be ranked, and the top set of results, along with web-viewable media files, returned. Location extraction indicates a place where the media was taken, such as for example, “Los Angeles” or “The Bahamas”. Person extraction indicates people in the media, such as “mom” or “Lisa”. Object extraction indicates objects seen in the original source video(s) and automatically detected, such as “sunset” or “plaid shirt”. Object extraction is useful because human memory is associative, and we often remember things not so much by what was said, but what we saw around us.

In some cases, a user may prefer a more conversational style of interacting with multiple search results. Phrases such as “Next” or “Show me twenty more” are interpreted as program control directives to the software to indicate whether to deliver another batch of results, and how many.

Natural language processing of the search sentence identifies the noun-phrases, verb-phrases, subjects, and objects in the sentence. For example, if a given word is identified as being the subject of the query, indexed content where the word is also a subject are likely to score higher.

Likewise, if a “question word” is present in the query based on the grammar tree, the system can invert a sentence to better match results with the intended query. Thus, a query for “What is a shark?” indicates the use of “What” as a question-word, and the search query can be inverted to be processed instead as “A shark is”—which is more likely to return useful results. Note that determining question-words is algorithmically complex and content-dependent—in a sentence like “Does this work” the word “Does” indicates a question whereas in a sentence like “Does eat grass” the word “Does” refers instead to female deer, and so a question-word is not present.

In some cases, a user may ask more open-ended questions, such as “How are you” or “What do you feel”. It is not desired to return search results where the user is talking about the phrase “how are you” or the phrase “what do you feel”—instead, the user wishes an answer to the question. In such cases, probable answers to these questions can be determined, and then searched, and the appropriate results delivered back. By performing a statistical analysis of the underlying language, it is possible to determine typical answers to given questions; this can be done by analyzing conversational dialog in electronic novels and film scripts, and creating a model, such as a Markov model, for what phrases typically follow other phrases, with associated probabilities. As an example, typical answers (and probabilities) to a question like “How are you?” might be “I feel fine” (50% of the time) “I feel great” (25% of the time) and “Okay, how are you” (for the remaining 25% of the time). Each of these three responses are searched in turn, and the highest-scoring result is returned, when the utterance probability is factored in as well. That is, if the user rarely says something like “I feel fine” but often says “I feel great” then “I feel great” will be scored higher.

The application that originated the query can then parse and process the results on behalf of the user, and provide one or more media files from the original user which then explains the results of the search, for example, what the user's favorite color was as a child.

### BRIEF DESCRIPTION OF THE DRAWINGS

FIG. 1 is a schematic illustration of an example embodiment of the present invention.

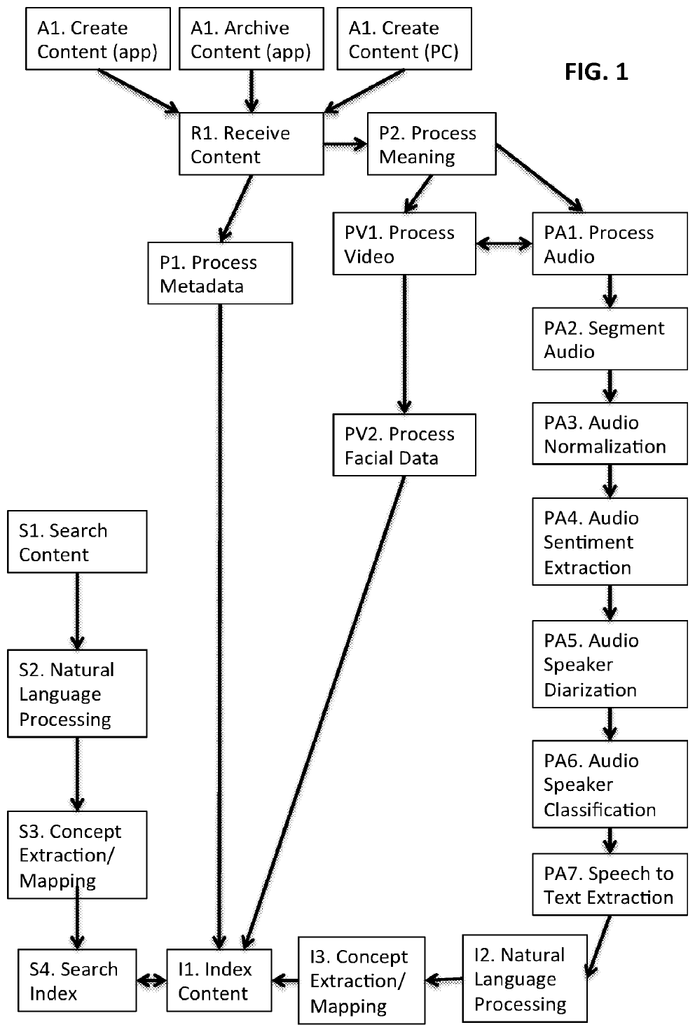

FIG. 2 is a schematic illustration of multiple user interaction.

FIG. 3 is a schematic illustration of valence and activation mapping.

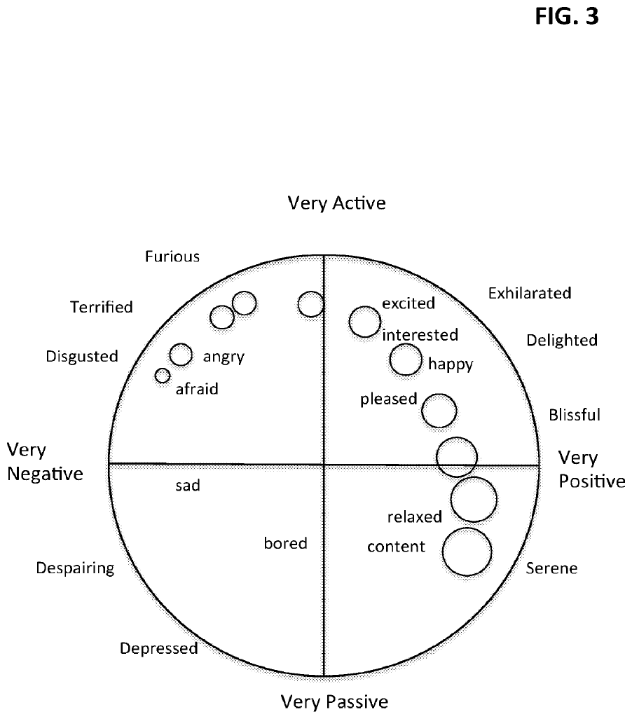

### MODES OF CARRYING OUT THE INVENTION, AND INDUSTRIAL APPLICABILITY

Blocks A1 and A2 can be accomplished by developing Objective C code for iOS and/or Java code for Android apps.

Block A3 can be accomplished with Objective C code for MacOS or .NET code for Windows systems.

Block R1 can be accomplished with a combination of cloud-hosted servers, listening to custom queues with HTTP endpoints for new data files and metadata descriptors. Files can be stored in a private cloud with appropriate backups and offsite data stores for archival.

Block P1 and P2 workflows can be accomplished by writing software, on cloud servers, using a variety of proprietary algorithms to extract meaning from files. Known open-source tools for extracting metadata can be used. The present invention is the first to integrate operations as in the blocks related to audio segmentation, audio sentiment extraction, and speaker classification. The I1, I2, and I3 blocks rely on a number of open-source software packages to perform individual analysis; the aggregate of all this analysis, especially as related to generation of meaning from data, is first presented in embodiments of the present invention.

The S blocks rely on HTTP and RCP processes to retrieve data from the user in a secure, scalable way, and delegate computation-intensive natural language processing and artificial intelligence term expansion tasks to dedicated cloud servers.

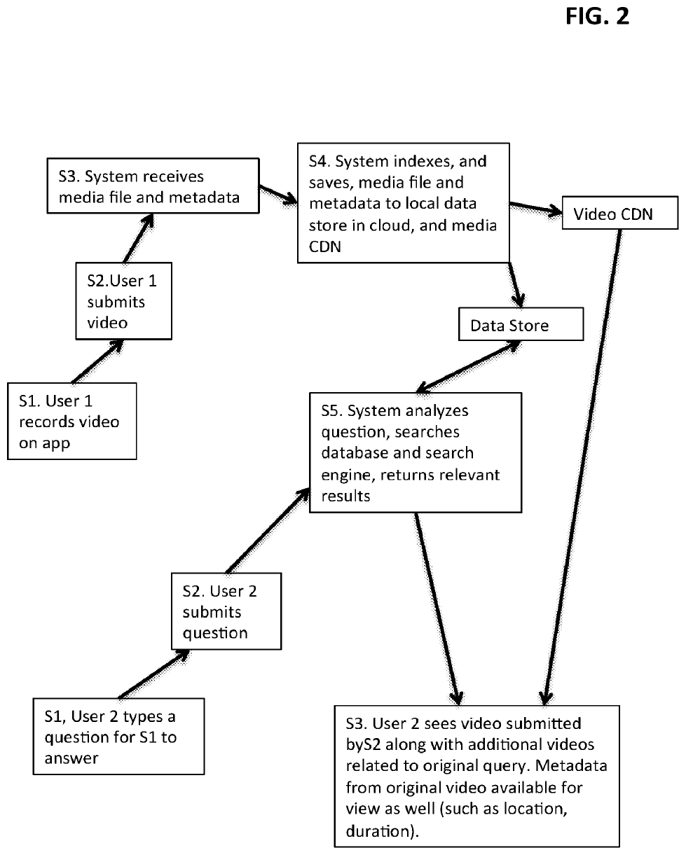

FIG. 2 is a schematic illustration of a block diagram of how multiple users can interact with an example embodiment of the system described herein, in the context of a family social network (such as in use case U1 above).

The present invention has been described in the context of various example embodiments. It will be understood that the above description is merely illustrative of the applications of the principles of the present invention, the scope of which is to be determined by the claims viewed in light of the specification. Other variants and modifications of the invention will be apparent to those of skill in the art.

1. A system for the storage and retrieval of digital content, comprising:
(a) an input system, configured to accept digital data having audio content, video content, or both;
(b) a data analysis system, configured to analyze content from the input system and determine from the content a plurality of characteristics concerning the content to associate with the content;
(c) a storage system, configured to store content and associated characteristics;
(d) a response system, configured to accept requests from a user, analyze the request to expand the scope of the request based on data in the request, access the storage system to identify content that matches the expanded request, and supply that content to the user.

2. A system as in claim 1, wherein the input system comprises a microphone, a video camera, or a combination thereof.

3. A method for determining metadata from audio recordings, comprising:
(a) accepting an item of digital content comprising an audio recording;
(b) Determining whether human speech is present in the content; and if so, then
(c) Determine an indication of volume in the content, and determine an adjustment factor to scale the content such that the volume is compatible with other audio content;
(d) Identify the number of speakers in the content;
(e) Determine the sentiment expressed in the content, corresponding to a score indicative of the mood of each human speaker in the content during each of one or more segments when such speaker is speaking;
(f) Produce a text representation of the recorded speech;
(g) Determine named entities present in the recorded speech;
(h) Determine polarity of the words in the speech;
(i) Determine related concepts that can be connected to words in the recorded speech;
(j) Storing the audio content in association with the speaker identities, the sentiment, the text, the named entities, and polarity, and the related concepts.

4. A system as in claim 1, wherein the analysis system is configured to determine acoustical energy, valence, or both, of a speaker in audio data.

5. A system as in claim 4, wherein the analysis system is configured to determine an adjusted acoustical energy, an adjusted valence, or a combination thereof, from audio data of a speaker and from previous audio data relating to the same speaker.

6. A system as in claim 1, wherein the analysis system is configured to extract information concerning the location where the context was generated, objects in view in the content, or a combination thereof.

7. A system as in claim 1, wherein the response system is configured to determine parts of speech in a user request, and to determine search characteristics based on meaning of words in the request and the parts of speech associated with such words.
